(19) United States
(12) Patent Application Publication
(10) Pub. No.: US 2017/0142482 A1
(43) Pub. Date: May 18, 2017

(54) VIDEO PLATFORM MONITORING AND ANALYZING SYSTEM

(71) Applicants: LE HOLDINGS (BEIJING) CO., LTD., Beijing (CN); LECLOUD COMPUTING CO., LTD., Beijing (CN)

(72) Inventor: Meng ZHOU, Beijing (CN)

(73) Assignees: LE HOLDINGS (BEIJING) CO., LTD., Beijing (CN); LECLOUD COMPUTING CO., LTD., Beijing (CN)

(21) Appl. No.: 15/252,353

(22) Filed: Aug. 31, 2016

Related U.S. Application Data
(63) Continuation of application No. PCT/CN2016/083159, filed on May 24, 2016.

(30) Foreign Application Priority Data
Nov. 13, 2015 (CN) 201510780835.8

(51) Int. Cl. H04N 21/442; H04N 21/858; H04N 21/81; H04N 21/258

(52) U.S. Cl. CPC H04N 21/44222; H04N 21/25891; H04N 21/25883; H04N 21/25858; H04N 21/8586; H04N 21/812

(57) ABSTRACT

Disclosed is a video platform monitoring and analyzing system including a video service module, a video service interface of a third-party platform, an analyzing and processing module, a user development package module and a customer service module. The video service module uploads video service data; the video service interface of the third-party platform uploads the video service data collected by the third-party platform; the user development package module sends user data; the analyzing and processing module analyzes and processes the received video service data and user data, and transmits an analysis result to the customer service module; and the customer service module displays the analysis result. The system is beneficial for a customer to grasp data information in real time, and to make a more effective business decision in a purposeful way.

### CROSS REFERENCE TO RELATED APPLICATIONS

This application is a continuation of International Application No. PCT/CN2016/083159, filed on May 24, 2016, which is based upon and claims priority to Chinese Patent Application No. 201510780835.8, filed on Nov. 13, 2015, the entire contents of which are incorporated herein by reference.

### TECHNICAL FIELD

The disclosure relates to the technical field of Internet technology, and more particularly to a video platform monitoring and analyzing system.

### BACKGROUND

There exist very aggressive competitions within a current overall context of high activity in the field of Internet, in particular in hot sectors such as network videos, e-commerce, social platforms, instant communications or the like. Internet companies serve, as providers of Internet services, on the one hand, are continually optimizing, modifying and transforming their original services to solidify their existing user groups, and on the other hand, are developing new and vibrant services to closely follow industry trends and get more new users and attention. After all, providing better user experience than competitors is exactly the key to attract users.

As big data advances, a need arises in the Internet field to monitor a variety of data, such as traffic analysis, service quality, user analysis, content analysis, playing analysis and the like, and to allocate and call resources more reasonably according to monitoring results.

Monitoring information is individually performed in the prior art. When mutual calls are desired between various kinds of information, the calls need to be made across platforms, which results in a low processing efficiency and is undesirable for unified monitoring and allocation of network resources.

### SUMMARY

The present application provides a video platform monitoring and analyzing system for solving a technical problem that various kinds of information is individually monitored in the prior art. When mutual calls are desired between various kinds of information, the calls need to be made across platforms, which results in a low processing efficiency and is undesirable for use of vast amounts of platform data and exploration of values from the platform data.

According to an aspect of the present application, there is provided a video platform monitoring and analyzing system including: a video service module of a current platform, a video service interface of a third-party platform, an analyzing and processing module, a user development package module and a customer service module, wherein:

the video service module of the current platform is configured to upload video service data of the current platform to the analyzing and processing module;

the video service interface of the third-party platform is configured to upload the video service data collected by the third-party platform to the analyzing and processing module;

the user development package module is configured to send user data using different user development packages to the analyzing and processing module;

the analyzing and processing module is configured to analyze and process the received video service data and user data, and to transmit an analysis result to the customer service module; and

the customer service module is configured to display the analysis result in a form of texts and graphics.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic view of an embodiment of the video platform monitoring and analyzing system of the present application;

FIG. 2 is a schematic view of an embodiment of the analyzing and processing module of the present application;

FIG. 3 is a schematic view of an embodiment of the data management unit of the present application;

FIG. 4 is a schematic view of an embodiment of the data storage unit of the present application;

FIG. 5 is a schematic view of an embodiment of the data processing unit of the present application; and

FIG. 6 is an architecture diagram in which the video platform monitoring and analyzing system of the present application is implemented.

### DETAILED DESCRIPTION

In order to make the purpose, technical solutions, and advantages of the embodiments of the application more clearly, technical solutions of the embodiments of the present application will be described clearly and completely in conjunction with the figures. Obviously, the described embodiments are merely part of the embodiments of the present application, but not all embodiments. Based on the embodiments of the present application, other embodiments obtained by the ordinary skill in the art without inventive efforts are within the scope of the present application.

It should be noted that, embodiments of the present application and the technical features involved therein may be combined with each other in case they are not conflict with each other.

The present application is applicable to various general-purpose and specific-purpose computer system environments or configurations, such as a personal computer, a server computer, a handheld device or portable device, a tablet device, a multi-processor system, a microprocessor-based system, a set-top box, a programmable consumer electronic device, a network PC, a mini-computer, a mainframe computer, a distributed computing environment including any of the above-listed systems or devices.

The present application can be described in a general context where a computer executes computer-executable instructions, such as program modules. Typically, program modules include routines, programs, objects, components, data structures, etc. which perform certain tasks or implement certain abstract data types. The present application can also be implemented in a distributed computing environment, where tasks are performed by a remote processing device connected through a communication network. In a distributed computing environment, program modules may be stored in storage mediums including memory device of the local and remote computer.

Finally, it should also be noted that, terms like “first” and “second: are merely for separating one entity or operation from the other, but not intended to require or imply a relation or sequence among these entities or operations. Further, terms like “comprise”, “include”, and the like are to be construed as including not only the elements described, but also those elements not specifically described, or further comprising elements which are essential to such process, method, article or device. Unless the context clearly requires, throughout the description and the claims, elements defined by recitation with “comprising . . . ” should not be construed as exclusive from the process, method, article or device comprising said elements of other equivalent elements.

In the embodiments of the application, hardware processor can be used to realize relevant functional module.

As shown in FIG. 1, the video platform monitoring and analyzing system of an embodiment of the present application includes a video service module of a current platform, a video service interface of a third-party platform, an analyzing and processing module, a user development package module and a customer service module, wherein

The video service module of the current platform is configured to upload video service data of the current platform to the analyzing and processing module.

The video service interface of the third-party platform is configured to upload the video service data collected by the third-party platform to the analyzing and processing module.

The user development package module is configured to send user data using different user development packages to the analyzing and processing module.

The analyzing and processing module is configured to analyze and process the received video service data and user data, and to transmit an analysis result to the customer service module.

The customer service module is configured to display the analysis result in a form of texts and graphics.

The video platform monitoring and analyzing system of the present embodiment can assist a customer in exploration of video values, improving an input-output ratio (ROI), controlling investment risks, presenting usage and industry dynamics of video switch a 360-degree panoramic view, closely tracking a change in interests of targeted user groups, reviving values of massive data, and can aid the customer in making refined operating decisions.

In this embodiment, the customer service module at least may perform an analysis from three aspects of live broadcasting, on demand broadcasting, and CDN network (performing a multi-level analysis and presentation in a form of data instrument panels, such as a live broadcasting instrument panel, an on-demand broadcasting instrument panel, and a CDN network instrument panel and the like, respectively). In this embodiment, taking the live broadcasting instrument panel as an example. Analyzing may include real-time analysis of the number of current online users, a current bandwidth, today's cumulative number of users, today's accumulated flow, current hot videos, a map of access sources, a trend ranking of video access; a trend analysis of the number of online users, a trend analysis of bandwidth; an average content viewing duration, a per capita viewing quantity for content, a content bounce rate; an analysis of traffic sources, whether the traffic comes from PC sides or mobile user sides, from new customers or old customers, from an IOS operating system or an Android operating system or the like; a user profile analysis that analyzes user's age, gender, consumption level, geographic distribution, hot tags of interest and the like.

A dashboard is a data visualization tool that not only may vividly present a data analysis result to the user but also may help the user analyze business problems in an interactive manner.

In this embodiment, an analysis and monitoring of the video platform is implemented by real-time display of the service data of video service module of the current platform (the service module at least includes one of a cloud live service, a cloud on-demand broadcasting service, a CDN file acceleration service, a streaming media distribution service, a small file acceleration service, and an advertising service) and the video service data collected by a third-party platform analyzed and processed by the analyzing and processing module through an instrument panel of the customer service module, such that an operator of the video platform may learn about operating conditions of the video platform in real time, and thus can employ a targeted strategy for the current operating state to ensure user experience in the case of normal operation of the video platform, to ensure a stable user group, and to provide reference basis to an operator of the video platform for making a reasonable operating strategy, thereby implementing transition from large amounts of service data to data values.

In addition, personalized needs of different customers are met by providing the video service interface of the third-party platform and the user development package. The customers may personalize a configuration of the system through the user development package module according to the actual needs of their own and upload a third-party log information on their own platforms to the system through the third-party platform video services, thereby implementing a personalized analysis and monitoring of the platform, and providing users with targeted and personalized strategy suggestions.

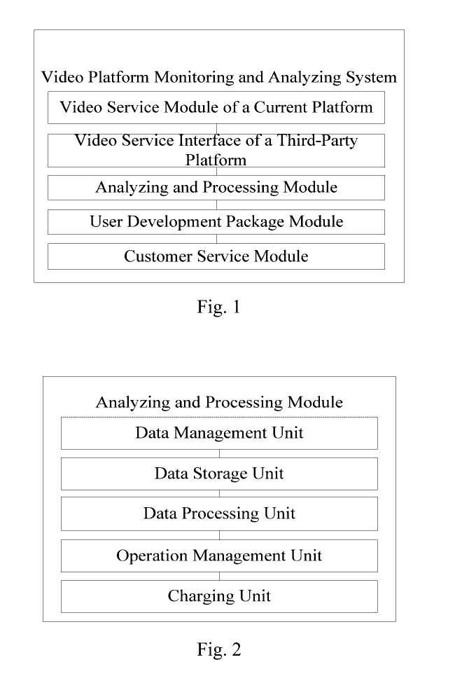

As shown in FIG. 2, in some embodiments, the analyzing and processing module includes a data management unit, a data storage unit, a data processing unit, an operation management unit and a charging unit.

The data storage unit is configured to receive the video service data of the current platform and the video service data collected by the third-party platform, and to obtain normalized data by performing a normalization process.

The data management unit is configured to screen out target data from the normalized data according to the user data sent by the user development package.

The data processing unit is configured to obtain an analyzing and processing result by performing on-line, along-line, and off-line processing of the target data.

The operation management unit is configured to perform counting and monitoring of operation data of the video platforms according to the analyzing and processing result.

The charging unit is configured to perform charging and costs accounting for the video platform according to the analyzing and processing result.

The analyzing and processing module in this embodiment is a server or a server cluster, wherein the data management unit, the data storage unit, the data processing unit, the operation management unit and the charging unit may be a separate server or server cluster, respectively. In this case, an interaction between the units presents as one between the server or server cluster corresponding to each unit.

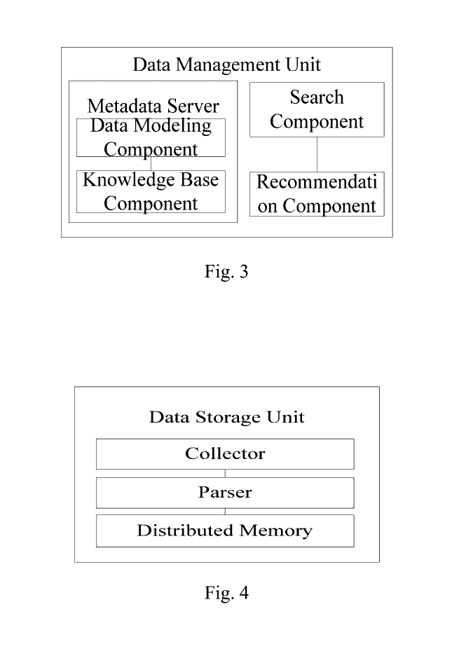

As shown in FIG. 3, based on the embodiments discussed above, the data management unit includes a metadata server having a data modeling component and a knowledge base component, a search component and a recommendation component.

The search component is configured to screen out target data according to the user data based on the data modeling component and knowledge base component; and/or

the recommendation component is configured to screen out the target data according to the user data based on the data modeling component and knowledge base component.

The data management unit in this embodiment is a server or a server cluster, wherein the metadata server having the data modeling component and the knowledge base component, the search component and the recommendation component may be a separate server or server cluster, respectively. In this case, interactions among the metadata server and the components are implemented as those among the servers or server clusters corresponding to each metadata server and each component.

The metadata server primarily functions to manage and operate metadata databases and metadata standards. The main functions are to register metadata standards, to establish metadata databases based on the metadata standards, to register and delete the metadata databases and metadata standards, to register and delete users, to change user passwords, to change user rights, to import the metadata standards in the metadata databases and the like.

Metadata, also referred to as intermediary data or relay data used for description of data about data, primarily functions to describe information on data properties for support of functions, such as indication of storage location, historical data, resource search, documentation and the like. The metadata is an electronic catalogue. In order to achieve a catalogue-making object, it is essential to describe and collect contents or features of data, thereby achieving an object of aiding in data retrieval.

The data management unit may be a DMP-Data Management Platform used for extracting valuable information from massive disordered data using big data technologies. Big data and DMP have a very bright prospect in the digital advertising field. With today's vigorous development of digital advertising, data explosion and advertising programmatic purchasing, the DMP assists advertisers in addressing big data processing problems by extracting valuable information from massive disordered data using big data technology.

The DMP can assist all parties involved in purchase and sale of advertising inventory in managing their data, using the third-party data more conveniently, enhancing their understanding of all those data, transmitting the data back or customizing data to transmit it to some platform for better positioning.

The DMP provides data support for DSP (Demand-Side Platform) by carrying out a standardized and tagging management of data from various sources, such that the DSP achieves a better delivery effect. The advertising programmatic purchasing makes a real-time directional delivery of advertisements possible and meanwhile also stimulates the entire industry to sell advertisements using data. The DMP implements an actual finding of personalized features of vast numbers of users, classifies those features, sticks labels thereon, and then recommends them to different types of advertisers. As a result, the value of DMPs cannot be underestimated in the RTB advertising industry chain.

As shown in FIG. 4, in some embodiments, the data storage unit includes a collector, a parser, and a distributed memory. The collector is configured to receive the service data and the third-party log, as well as the video service data, the parser is configured to normalize the video service data, and the distributed memory is configured to store the normalized data.

The distributed memory provides advantages in that physical mediums are distributed to different geographic locations, a plurality of low-end small-capacity storage devices with lower prices and maintenance costs may be used for distribution and deployment, and the distribution and deployment of small-capacity devices have a low requirement for computer room environments.

The data storage unit in this embodiment is a server or a server cluster, wherein the collector, the parser, and the distributed memory may be a separate server or server cluster, respectively. In this case, interactions among the collector, the parser, and the distributed memory are implemented as those among the servers or server clusters corresponding to the collector, the parser, and the distributed memory.

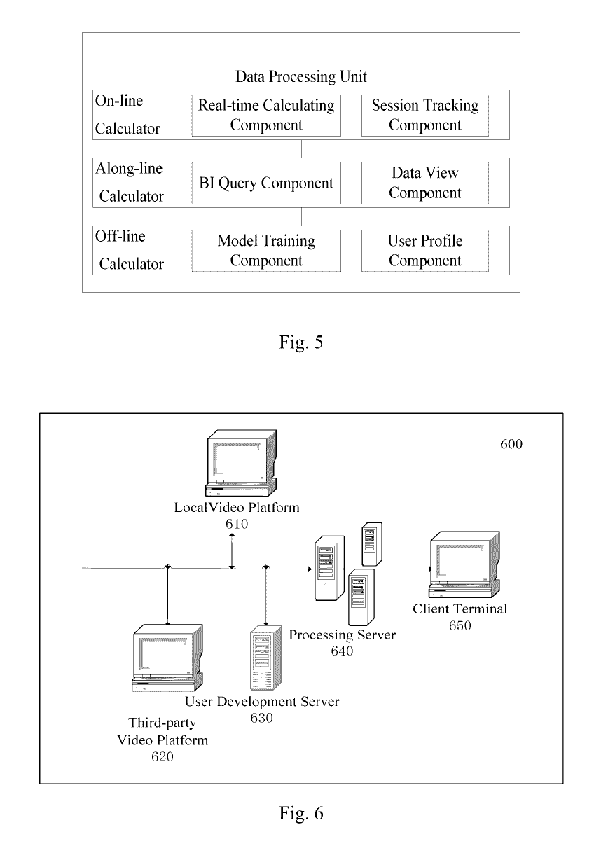

As shown in FIG. 5, in some embodiments, the data processing unit includes on-line, along-line, and off-line calculators.

The on-line calculator includes a real-time calculating component and a session tracking component. The real-time calculating component is configured to at least analyze current hot videos, a trend ranking of video access and a regional ranking of video access of the video platform; and the session tracking component is configured to track a user's access action in real time.

The along-line calculator includes a business intelligence query component and a data view component. The business intelligence query component is configured to query relevant information depending on customer requirements, and the data view component is configured to generate text and graphics information based on the relevant information.

The off-line calculator includes a model training component and a user profile component. The model training component is configured to select a data model based on a user behavior, and the user profile component is configured to draw a user profile based on the data model.

The on-line, along-line and off-line calculators in this embodiment may be separate servers or server clusters.

In this embodiment, customers can provide a more reasonable arrangement of programs with respect to the current hot videos, the trend ranking of video access and the regional ranking of video access by analyzing the current hot videos, the trend ranking of video access and the regional ranking of video access in real time by the real-time calculating component and presenting to users, thereby achieving better promotional effects. Accordingly, users can carry out more promotions of value added services, and lock a larger number of users, and develop a corresponding advertisement delivery scheme, thereby achieving better delivery benefits of advertisements. In addition, users can specifically focus on serving regions where an amount of access is top ranked according to the difference in the regional ranking of video access. Since an ordinary video platform has a limited serving capability, allocating resources in such a focused manner is useful to ensure a higher quality service for customers in circumstances where resources are limited, and to enhance user experience. To be specific, according to the type of the current hot videos, it is possible to deliver a type of video identical or similar to its type, so as to acquire a larger number of clicks from users. And the low-ranking video resources can be removed according to the conditions of the trend ranking of video access, so as to leave more space for the current hot videos.

The session tracking component in this embodiment may be tracked in four manners as follows.

1. Continuously Using Cookie. For Example:

String sessionID=makeUniqueString( );

### HashMapseesionInfo=new HashMap( );

HashMapglobalTable=findTableStringSession( );
globalTable.put(sessionID,sessionInfo);
Cookie sessionCookies=new Cookie(“JSESSIONID”,sessionID);
sessionCookie.setPath(“/”);
reponse.addCookie(sessionCookie).

Those pieces of codes in the above may first record session information in HashMap, store it in the server side, and identify it with sessionID, and then store the sessionID in a Cookie called “JSESSIONID”. After the user requests reach the server, the sessionID is first removed from the Cookie, and then the session information is removed from the HashMap, thereby implementing a session tracking.

2. Rewriting a URL Including Additional Parameters.

URL rewriting achieves an object of session tracking by adding some additional parameters at the end of URL using a GET method. The server associates such identifier with data related to the session in which the identifier is stored. The URL appears http://localhost/file.html; jsession=1234, for example.

3. Establishing a Hidden Form Field Including Data.

Client information along with requests is sent to the server for processing using hidden attributes within HTML without being aware of by the users.

For instance, <input type=“hidden” name=“userID” value=“15”>.

4. Using Built-in Session Objects.

A session mechanism of built-in session objects of JSP is based on a Cookie or URL rewriting technology by combining advantages of the two technologies. When the client allows use of Cookie, the built-in session objects perform a session tracking using the Cookie, and if the client disables the Cookie, the URL rewriting is selected.

A BI (Business Intelligence) is a brand new technology of processing and analyzing data using technologies, such as a data warehousing, an on-line analysis, a data mining and the like, for purposes of providing decision supports to business decision makers.

A data query is the simplest BI application. At present, the tool at the highest level is a browser-supported full drag interface, which organizes query conditions by itself, completely releases flexibility of data query, e.g., a data query interface Query Editor of Yonghong Z-Suite, allows users to define elements of the data query by drag operations with mouse through a browser interface alone, and to present data in various ways, such as charts and tables and the like. However, the basic underlying is still based on database SQL query being applied today.

Defining data models by configuring the model training component according to customer requirements, to fit the user profile component for implementation of classification of users' different dimensions (the user profile component at least includes age, gender, consumption level, geographic distribution, and near-term points of interest). The age, gender, consumption level, geographic distribution, and near-term points of interest of the users who pay attention to the video platform may be further learned, and thus a service promotion of products in which various ages are interested can be pushed for particular ages depending on specific circumstances, and a more targeted and more effective promotion is carried out according to gender differences. More accurately priced products can be launched with respect to the consumption levels, so as to improve an achievement rate of orders. Service promotions can be performed for different regions according to differences in regional culture. In addition, an analysis result of each analysis module is presented in a form of texts and graphics by a text and graphics generation module, which is more helpful for the users to visually make a comparative analysis and assists the users in making decisions for different services more efficiently.

The user profile in this embodiment further includes information such as user's occupation, propensity, activity, operating records and the like. The user profile can be described from many dimensions, and in each dimension, there are a number of corresponding tag names indicative of users′attributes in the dimension. For example, in this embodiment, the age, gender and occupation are dimensions that describe the features of the users themselves. Regarding such a dimension as age, the corresponding tag names are <0-15 years>, <15-25 years>, <35-50 years> and <50 years and above>. Each user surely has a tag name corresponding to the specific condition in the dimension. Likewise, the tag names corresponding to gender comprise <male> and <female>. The tag names corresponding to the occupation dimension comprise <engineer>, <teacher>, <doctor>, <legal practitioner>, <civil servant> or the like. Dimensions such as the propensity, activity, operating records and the like, describe the particular conditions that a user uses network services. The propensity dimension may measure a user's interest propensity, including tag names such as <television show>, <movie>, <variety show> or the like. The activity dimension may measure a frequency at which the users participate in network services. The operating records dimension concretely records the content the users have visited.

Since the analysis method in this embodiment is extremely open, the larger the user information sample being stored, the more comprehensive the overlay content, the richer the analyzed result. As a result, the actual user database includes a tremendous variety of dimensions and tag names corresponding thereto, which will not be further enumerated herein.

The user near-term points of interest are acquired by acquiring the user's viewing history, the type of video favored by the user is determined by analyzing the user's viewing history, and thus the corresponding reminder message of user preference is pushed to a playing interface of the user terminal. As a result, a three-dimensional video recommendation for individual user's preferences and habits is implemented, and therefore an accuracy of video recommendation is significantly improved.

In particular, the user can first complete a login operation at the user terminal before the server acquires the user's viewing history. For example, the user can log in some client or website using a user name of “15224945611” and a password of “123321”. In such case, the server acquires the viewing history of the user matching the user name of “15224945611”, where the viewing history may include an MAC (Media Access Control) address. In particular, the MAC address is used to denote identifiers of each site on the Internet, represented in hexadecimal notation in 6 bytes in total (48 bits). Amongst these, the first three bytes (high bits-24 bits) are codes assigned to different manufacturers by the IEEE Registration Authority (RA), also referred to as “organizationally unique identifier”, and the last three bytes (low bits-24 bits) are assigned to the manufactured adapter interface by each manufacturer on its own initiative, also referred to as “extended identifier” (uniqueness). An address block can generate 2̂24 different addresses, and each network location has a MAC address dedicated thereto.

The server counts the number of clicks for different types of video from users according to the viewing history. In particular, the server may count search keywords and click-through rates within the website, and record the relevant keywords and click-through rates. If statistical analysis data is greater than the predetermined threshold within the system, the video information is marked.

For instance, a certain user chooses to watch a news report in a video program database of some website in the morning, the server counts the number of search volumes and click-through rates of the relevant type of videos after receiving a watching instruction. If the counting number of an electronic device is greater than the threshold, the system may put a mark on such report that the user likes to watch news report in the morning.

The server determines the type of video favored by the user according to the number of user's clicks for different types of video. Amongst these, the type of video favored by the user is the most-clicked one. Alternatively, the type of video favored by the user may also be one for which the number of clicks is in a preset interval of number of clicks. For example, if the type of video corresponding to keywords for which the preset number of clicks is greater than 15 is one favored by the user, and if the user plays some war episode in the 16^{th} click, the server determines the type of video favored by the user is a war show.

In particular, the server determines the type of video favored by the user by counting and analyzing the type of video for which the statistical analysis data is greater than the predetermined threshold within the system, and hence marking the video information after counting the number of clicks for different types of video according to the viewing history.

The server generates a reminder message of user preference and pushes it to the user terminal, according to the type of video favored by the user. Amongst these, the reminder message of user preference includes video information corresponding to the type of video favored by the user. In general, the pushed video may not be the video in the viewing history.

In particular, the server adds a link to a corresponding video to the reminder message of user preference, establishes a link relation between the reminder message of user preference and a playing page of the corresponding video, and hence outputs the reminder message of user preference to the user terminal after determining the type of video favored by the user according to the number of clicks for different types of video. After the user clicks the reminder message of user preference, a video recommendation is completed by linking to the corresponding playing interface.

In some embodiments, the operation management unit includes a counting component and a monitoring component.

The counting component is configured to count the number of current online users, a current bandwidth, an accumulated number of visitors, and an accumulated flow of the video platform.

The monitoring component is configured to monitor a trend of the number of online users and a trend of bandwidth occupation of the video platform.

It is possible, by monitoring the number of current online users and cumulative number of visitors of the video platform by the counting component in real time, to derive information, i.e., in what time period of a day does the visiting reach the most and in what day of a year the largest cumulative number of visitors occurs and the like according to these data, to facilitate a subsequent trend analysis module to predict the number of visitors in the future according to the historical data, thereby calling network resources more reasonably, e.g., bandwidth resources and traffic resources and the like, for the video platform. Meanwhile more services, e.g., placing advertisements in videos or web pages, may also be promoted at traffic peaks.

In some embodiments, the charging unit includes a charging component and a cost actuarial component.

The charging component is configured to calculate an accumulated amount of consumption for the customer in real time.

The cost actuarial component is configured to calculate an operating cost of the video platform in real time.

In this embodiment, the customers and operators may learn about their own consumptions and earnings in real time by providing the charging unit and the cost actuarial unit, and predict the late consumptions and earnings according to the current consumptions and earnings, so that reliable reference information is provided for setting up the late operational capital budget in advance and more reasonable deployment strategies are developed.

In some embodiments, in the video platform monitoring and analyzing system, the customer service module includes:

an instrument panel for displaying service parameters of the video platform; and

an analysis component for analyzing operations of the video platform.

The analysis component performs analysis in aspects of traffic analysis, service quality analysis, user analysis, content analysis and the like.

The traffic analysis aspect mainly relates to a bandwidth query, a traffic query, a region query, an ISP (Internet Service Provider) query, a request number query, a back-to-source ratio query and the like.

The service quality analysis aspect mainly relates to stutter ratio statistics, slow speed ratio statistics, smooth video project statistics, bounce rate statistics and the like; the user analysis aspect mainly relates to a user profile analysis, a user number query, a user activity analysis and the like; and the content analysis aspect mainly relates to a top ranking analysis.

In some embodiments, the video platform monitoring and analyzing system of the present application further includes analyzing bandwidth, traffic, ISP (Internet Service Provider), the number of requests of the video platform.

In this embodiment, a multi-dimension analysis query is performed for bandwidth and traffic of the video platform, e.g., bandwidth usage may be reviewed at different granularities through division of time, the bandwidth usage may also be reviewed in different regions through restriction of region, the bandwidth usage of different internet service providers is reviewed through selection of internet service providers, and the like, so that a precise monitoring of bandwidth usage is implemented. Meanwhile, it is possible to review in real time traffic conditions of different internet service providers, such as Telecom, Unicom, Mobile, Great Wall, overseas, China Tietong (CTT), ChungHwa Telecom, TV Network, HKBN, and the like, so as to more reasonably select an Internet service provider as a cooperation partner.

In the video platform monitoring and analyzing system of the present application in some embodiments, the real-time analysis component is further configured to analyze a slow speed ratio, and a stutter ratio of the video platform.

In this embodiment, it is possible to get to know the quality of the network services to users in real time by counting the slow speed ratio and stutter ratio of the video platform, so as to make a real-time adjustment, to ensure the service quality and to enhance user experience for obtaining a more stable and healthier user group.

In some embodiments, the video platform monitoring and analyzing system of the present application further includes a reporting component generating a text and graphics file based on the analysis result, configured to generate a report file based on the analysis result of each analysis module, and a downloading component for downloading the text and graphics file. In this embodiment, a customized report file is formed with respect to the analysis results of different analysis modules for the video platform operator's reference, so as to make a more accurate and effective, and highly specific business adjustment decision.

It should be noted that for each of the method examples described above, for the ease of description, it is thus described as a combination of a series of actions. However, those skilled in the art will appreciate that the present application is not limited to the described action sequence. As based on the present application, some steps can be performed in other order or at the same time. Next, those skilled in the art also will appreciate that the embodiments described in the Description are preferred ones, and the involved actions and modules are not essential in the present application.

In the above-mentioned examples, the description of each example is emphasized individually. No detailed description exists in some embodiments, reference can be made to the related description of other embodiments.

The video platform monitoring and analyzing system of the present application is used in a process of assisting customers in better utilizing data, enhancing quality of decision, and extracting information and knowledge from large amounts of data. In brief, a process of business, data, and data value application. The BI query in the present application is a comprehensive platform in which data are deeply analyzed within each sub-product line. The customers can implement data queries in multiple dimensions and in different sizes, and quickly answer to complex business questions through the product of this application. All analysis indexes are mutually correlated and interpenetrated to form a huge system, which is interpreted using big data from five aspects: traffic analysis, service quality, user analysis, content analysis, playing analysis, so as to assist the customers in quickly “concentrating on the main points”, to assist the customers in exploring the video value, enhancing an input-output ratio (ROI), and controlling investment risks. The present application can produce the following effects: presenting usage conditions and industry dynamics of the videos with a 360-degree panoramic view, closely tracking a change in interests of targeted user groups, reviving values of massive data, improving profitability of video advertisements bases on the analysis, and aiding the customers in making refined operating decisions.

The customers in the video industry chains may implement realization and appreciation of digital assets through the video platform monitoring and analyzing system of the present application in various ways:

for radio and television enterprises: periodically reviewing viewing figures, adjusting a combination of new programs to ensure user override;

for producers: generating resonance with the audiences by evaluating different actors or actresses with data;

for e-commerce operators: making user action chains complete, identifying a potential consumer group, and enhancing an ordering rate;

for marketing: establishing a channel mix module and increasing a brand exposure and audience participation;

for advertising: establishing a plurality of combinations of delivery forms and target distributions and finding an equilibrium point between advertisements and show time;

for mega-event operating: perceiving in advance a sharp increase in peaks, automatically switching an alternative scheme and ensuring service effectiveness.

FIG. 6 shows an architecture diagram in which the video platform monitoring and analyzing system of the present application is implemented. The video platform monitoring and analyzing system 600 in this embodiment includes a local video platform 610, a third-party video platform 620, a user development server 630, a processing server 640, and a client terminal 650. Amongst these, the local video platform 610, the third-party video platform 620, the user development server 630, and the client terminal 650 are in communications connection to the processing server 640 via a data bus, respectively. The local video platform 610, the third-party video platform 620, the user development server 630, the processing server 640, and the client terminal 650 in this embodiment correspond to each of the modules and interfaces as shown in FIG. 1, respectively. Amongst these, the local video platform 610 corresponds to the video service module of the current platform; the third-party video platform 620 uploads the video service data collected by the third-party platform to the analyzing and processing module (i.e., the processing server 640) via the video service interface of the third-party platform; the user development server 630 corresponds to the user development package module, to send user data using different user development packages to the analyzing and processing module (i.e., the processing server 640); the processing server 640 corresponds to the analyzing and processing module, to analyze and process the received video service data and user data and to transmit an analysis result to the customer service module (the client terminal 650).

In this embodiment, the local video platform 610, the third-party video platform 620, the user development server 630, the processing server 640, and the client terminal 650 may be a separate server or server cluster, respectively. In this case, interactions among the local video platform 610, the third-party video platform 620, the user development server 630, the processing server 640, and the client terminal 650 are actually those among the servers or server cluster corresponding thereto.

The foregoing embodiments of device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features making contribution to the prior art may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

It would be appreciated by the skilled in the art that, the embodiments of the present application can be provided as method, system, or computer program product. Therefore, the present application can be implemented in various ways, such as purely by hardware, or purely by software, or a combination of software and hardware. Moreover, the present application can be implemented as a computer program product including one or more computer executable program codes which are stored on a computer readable memory medium (including but not limited to a disk storage or optic memory, etc.).

The present application is described in reference to method, device (or system), and flow chart and/or block diagram of computer program product of embodiment of the application. It should be understood that each flow and/or block and a combination thereof in a flow chart and/or block diagram can be implemented by computer program instruction. These computer program instruction can be provided to a universal computer, a dedicated computer, an embedded processor or a processor of other programmable data processing device to generate a machine, so that a device capable of realizing functions designated by one or more flows of a flow chart and/or one or more blocks of a block diagram can be generated through execution of instructions by a computer or processor of other programmable data processing device.

These computer program instructions may be stored in a computer readable memory which can guide the computer or other programmable data processing device to operate in a special way, so that the instruction stored in the computer readable memory generates a product including an instruction device which carries out functions designated by one or more flows of a flow chart and/or one or more blocks of a block diagram. These computer program instructions can also be loaded on a computer or other programmable data processing device so as to enable a series of operations to be carried out on the computer or other programmable device to realize processing of the computer, thus providing operations for achieving functions designated by one or more flows of a flow chart and/or one or more blocks of a block diagram by the instructions executed by the computer or other programmable device.

The above embodiments are merely provided for describing the technical schemes of the present application, but not intended to limit the same. Although the present application has been described in detail with reference to the above embodiments, those skilled in the art will appreciate that the technical schemes described in the above embodiments may be modified, or part of technical features in the embodiments may be replaced with equivalents without departing from the spirits and scopes of the technical schemes of all the embodiments of the present application.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

What is claimed is:

1. A video platform monitoring and analyzing system for a video platform, comprising:
an analyzing and processing module;
a video service module of a current platform uploads video service data of the current platform to the analyzing and processing module;
a video service interface of a third-party platform uploads the video service data collected by the third-party platform to the analyzing and processing module;
a user development package module sends user data using different user development packages to the analyzing and processing module;
the analyzing and processing module analyzes and processes video service data received from the video service module and user data, and transmits an analysis result to a customer service module; and
the customer service module is configured to display the analysis result in a form of texts and graphics.

2. The system of claim 1, wherein the analyzing and processing module comprises a data management unit, a data storage unit, a data processing unit and an operation management unit, wherein
the data storage unit receives the video service data of the current platform and the video service data collected by the third-party platform, and to obtain normalized data by performing a normalization process;
the data management unit screens target data from the normalized data according to user data sent by the user development package;
the data processing unit obtains an analyzing and processing result by performing on-line, along-line, and off-line processing of the target data; and
the operation management unit performs counting and monitoring of operation data of the video platforms according to the analyzing and processing result.

3. The system of claim 2, further comprising a search component, a knowledge base component, and a data modeling component, wherein
the search component screens out the target data according to the user data based on the data modeling component and knowledge base component; and/or
the recommendation component screens out the target data according to the user data based on the data modeling component and knowledge base component.

4. The system of claim 2, wherein the data storage unit comprises a collector, a parser, and a distributed memory; the collector receives the video service data; the parser normalizes the video service data; and the distributed memory stores the normalized data.

5. The system of claim 2, wherein the data processing unit comprises an on-line calculator, an along-line calculator, or an off-line calculator, and wherein:
the on-line calculator comprises a real-time calculating component and a session tracking component, wherein the real-time calculating component at least analyzes current hot videos, a trend ranking of video access and a regional ranking of video access of the video platform, and the session tracking component tracks a user's access action in real-time;
the along-line calculator comprises a business intelligence query component and a data view component, wherein the business intelligence query component queries relevant information depending on requirements, and the data view component generates text and graphics information based on the relevant information; and
the off-line calculator comprises a model training component and a user profile component, the model training component selects a data model based on a user behavior, and the user profile component draws a user profile based on the data model.

6. The system of claim 2, wherein the operation management unit comprises a counting component and a monitoring component;
the counting component counts a number of current online users, a current bandwidth, an accumulated number of visitors, or an accumulated flow of the video platform; and
the monitoring component monitors a trend of the number of online users and a trend of bandwidth occupation of the video platform.

7. The system of claim 1, wherein the customer service module comprises:
an instrument panel for displaying service parameters of the video platform; and
an analysis component for analyzing operations of the video platform.

8. The system of claim 7, wherein the customer service module further comprises:
A reporting component configured to generate a text and graphics file based on the analysis result; and
a downloading component configured to download the text and graphics file.

9. The system of claim 8, wherein the instrument panels comprise a live broadcasting instrument panel, an on-demand broadcasting instrument panel, or a CDN network instrument panel,
and the live broadcasting instrument panel, on-demand broadcasting instrument panel, and CDN network instrument panel display the analysis result in a form of texts and graphics, respectively.

10. The system of claim 1, wherein the video service module of the current platform comprises a cloud live broadcasting unit, a cloud on-demand broadcasting unit, a CDN file acceleration unit, a stream media distribution unit, a small file acceleration unit, or an advertising unit.

11. An electronic device comprising:
at least one processor; and
a memory communicably connected with the at least one processor for storing instructions executable by the at least one processor, wherein execution of the instructions by the at least one processor causes the at least one processor to:
obtaining video service data of a current platform;
obtaining video service data of a third-party platform;
obtaining user data;
analyzing and processing the video service data of the current platform, video service data of the third-party platform and user data; and
displaying analysis result in a form of texts and graphics.

12. The electronic device of claim 11, wherein execution of the instructions by the at least one processor further causes the at least one processor to
receive the video service data of the current platform and the video service data collected by the third-party platform, and to obtain normalized data by performing a normalization process;
screen target data from the normalized data according to the user data;
obtain an analyzing and processing result by performing on-line, along-line, and off-line processing of the target data; and
perform counting and monitoring of operation data of the video platforms according to the analyzing and processing result.

13. The device of claim 12, wherein execution of the instructions by the at least one processor further causes the at least one processor to
screen out the target data according to the user data through data modeling and a knowledge base; and/or
screen out the target data according to the user data based on the data modeling and the knowledge base.

14. The device of claim 11, wherein execution of the instructions by the at least one processor further causes the at least one processor to receive the video service data, normalize the video service data, and store the normalized data.

15. The device of claim 12, wherein execution of the instructions by the at least one processor further causes the at least one processor to
analyze current hot videos, a trend ranking of video access and a regional ranking of video access of the video platform, and track a user's access action in real-time;
query relevant information depending on requirements, and generate text and graphics information based on the relevant information; and
select a data model based on a user behavior, and draw a user profile based on the data model.

16. The device of claim 12, wherein execution of the instructions by the at least one processor further causes the at least one processor to
count a number of current online users, a current bandwidth, an accumulated number of visitors, or an accumulated flow of the video platform; and
monitor a trend of the number of online users and a trend of bandwidth occupation of the video platform.

17. The device of claim 11, wherein execution of the instructions by the at least one processor further causes the at least one processor to
providing an instrument panel for displaying service parameters of the video platform; and
analyzing operations of the video platform.

18. The device of claim 17, wherein execution of the instructions by the at least one processor further causes the at least one processor to
generate a text and graphics file based on the analysis result; and
download the text and graphics file.

19. The device of claim 18, wherein the instrument panels comprise a live broadcasting instrument panel, an on-demand broadcasting instrument panel, or a CDN network instrument panel which display the analysis result in a form of texts and graphics, respectively.
